(19) United States
(12) Patent Application Publication
(10) Pub. No.: US 2012/0040065 A1
(43) Pub. Date: Feb. 16, 2012

(54) CARBOXYMETHYL CELLULOSE WITH IMPROVED PROPERTIES

(75) Inventors: Roland Adden, Walsrode (DE); Britta Huebner-Keese, Uctze (DE); Carsten Huettermann, Bremen (DE); Matthias Sprehe, Walsrode (DE)

(73) Assignee: Dow Global Technologies Inc., Midland, MI (US)

(21) Appl. No.: 13/145,945

(22) PCT Filed: Mar. 30, 2010
(86) PCT No.: PCT/US10/29195

§ 371 Date: Oct. 18, 2011

Related U.S. Application Data
(60) Provisional application No. 61/164,949, filed on Mar. 31, 2009.

(51) Int. Cl. C08B 15/02; A23L 1/0534

(52) U.S. Cl. 426/453; 536/56

(57) ABSTRACT

The present application relates to processes for imparting improved properties to carboxymethyl cellulose, for example, a process for producing an aqueous dispersible carboxymethyl cellulose is described, comprising introducing carboxymethyl cellulose into a high shear mixer, adding at least 20 percent water by weight to the carboxymethyl cellulose without additional surface treatment additives, forming carboxymethyl cellulose agglomerates, and drying the agglomerates by non-contact drying means to form the aqueous dispersible carboxymethyl cellulose.

### FIELD

The present application relates to processes for imparting improved properties to carboxymethyl cellulose.

### BACKGROUND

The polymeric backbone of cellulose is a repeating structure of anhydroglucose units. Treatment of cellulosic fibers with caustic solution, followed by chloroacetic acid, yields cellulose ethers substituted with carboxymethyl groups, a cellulose derivative referred to as carboxymethyl cellulose (“CMC”). CMC is normally sold in solid, dry, form, and hence its powder handling and processing properties are extremely important.

For example, a low dust content is desirable for dry CMC. Also, the ability of the dry CMC to be poured from a container or receptacle is described as flowability. Flowability is affected by particle shape and size distribution, and resulting bulk density. Bulk density is the mass of powdered solid material per unit of volume occupied. Acceptable flowability generally depends upon relatively high bulk density and relatively low angle of repose. The angle of repose is the maximum angle between the slope of a conical discharged pile of powder and the surface it rests upon, a lower angle representing a more widely spread pile.

Often, it is desirable to put CMC in solution as part of using it in its various applications. Dissolution is frequently described as a process with two overlapping phenomena, dispersion and hydration. Dispersion refers to spreading of particles or groups of polymer chains throughout the solution. Hydration refers to loosening of the polymer chains and expansion of their hydrodynamic volume (and corresponding viscosity buildup). If dispersion is poor, or if hydration outpaces dispersion, hydrated polymer can swell and isolate relatively dry, non-hydrated polymer from the solution, forming lumps. It has long been a goal in the industry to produce CMC which is readily dispersible and hydrates quickly in aqueous solutions, more particularly at room temperature. Desirable dispersion and hydration are normally characterized by little to no lump formation and a rapid viscosity build up over time, respectively.

Thus, what is needed is a process for making a CMC that shows desirable dispersion and hydration, yet exhibits good flowability and low dust content.

### SUMMARY

In one embodiment, the present invention provides process for producing an aqueous dispersible carboxymethyl cellulose, comprising introducing carboxymethyl cellulose into a high shear mixer, adding at least 20 percent water by weight to the carboxymethyl cellulose without additional surface treatment additives, forming carboxymethyl cellulose agglomerates, and drying the agglomerates by non-contact drying means to form the aqueous dispersible carboxymethyl cellulose.

### DETAILED DESCRIPTION

In one embodiment, the present invention provides process for producing an aqueous dispersible carboxymethyl cellulose, comprising introducing carboxymethyl cellulose into a high shear mixer, adding at least 20 percent water by weight to the carboxymethyl cellulose without additional surface treatment additives, forming carboxymethyl cellulose agglomerates, and drying the agglomerates by non-contact drying means to form the aqueous dispersible carboxymethyl cellulose. In a preferred embodiment, the introduction step is in a continuous process, but the process may be carried out in a batch or semi-batch process in alternative embodiments.

The term “aqueous dispersible carboxymethyl cellulose” refers to a CMC which exhibits improved dispersibility in aqueous solutions.

The step of introducing carboxymethyl cellulose into a high shear mixer refers to unprocessed, raw material CMC. In one embodiment, the raw material CMCs have a viscosity of about 1 to about 120,000 mPa/s for a two percent solution by weight at 25° C. For example, a relatively low viscosity 30 mPa/s CMC is commercially available from The Dow Chemical Company under the tradename WALOCEL CRT 30; a medium viscosity 2000 mPa/s CMC is commercially available from The Dow Chemical Company under the tradename WALOCEL CRT 2000; and, a relatively high viscosity 40,000 mPa/s CMC is commercially available from The Dow Chemical Company under the tradename WALOCEL CRT 40000.

Some carboxymethyl cellulose features, like degree of substitution, remain constant throughout the process. The term “DS” refers to the degree of carboxymethyl substitution per anhydroglucose unit. All CMC grades are contemplated, thus the DS may be from about 0.5 to about 1.4, preferably from about 0.6 to about 1.0, and more preferably, the DS is about 0.7 to about 0.9.

Physical features of carboxymethyl cellulose, however, will be changed by the currently described process. Raw material CMC has a bulk density of about 550 to about 675 g/L, and an angle of repose of about 41° to about 42°, and thus has excellent flowability, however, raw material CMC is not generally considered dispersible in aqueous solutions at room temperature and is very slow to hydrate. Raw material CMC also retains a large percentage of dust, i.e., particles with less than a 64 micron article size.

One conventional way to make raw material CMC more dispersible in aqueous solutions at room temperature and improve hydration is to process the raw material CMC in a fluid bed agglomerator. However, as will be shown in the Examples, this has the deleterious effect of lowering the bulk density and increasing the angle of repose, which in turn decreases flowability.

Contemplated high shear mixers include ring layer mixers, Ploughshare mixers, Schugi mixers, and Turbulizer mixers. In a preferred embodiment, the high shear mixer is a ring layer mixer. A ring layer mixer generally comprises a horizontal drum with a mixing shaft axially disposed in it. The mixing shaft has blades, bolts, and/or paddles protruding from it. Mixing shaft geometry can create various mixing zones for transporting, dispersing, mixing, and the like. The product to be mixed forms a concentric ring via centrifugal force, and moves through the mixer in plug-like flow. Liquid is added through a hollow shaft or by injection through special perforated mixing tools. The residence time varies with rpms, flow rate, amount of material, drum length, and selected mixing shaft geometry. A suitable ring layer mixer can be procured from Loedige (Paderborn, Germany), under the tradename CORIMIX CM 20.

In an alternative embodiment of the present invention, the high shear mixers can be replaced by a flow jet mixer.

In one embodiment, the process step of adding at least 20 percent water by weight to the carboxymethyl cellulose without additional surface treatment additives includes adding, without additional surface treatment additives, at least 25, or at least 30, or, if conditions are selected to discourage granulation, at least 35 percent water by weight to the carboxymethyl cellulose. Previous methods required the use of surface treatment additives, for example, salts, sugars, surfactants, and/or glycols. It has now been surprisingly found that the present process can achieve excellent results without surface treatment additives.

Typically, those skilled in the art seek to minimize agglomeration and encourage granulation. It has now been surprisingly found that the present process can achieve excellent results by proceeding contrary to the conventional wisdom. Accordingly, in one embodiment, the process further comprises adjusting the residence time in the ring layer mixer, for example, rpms and mixing shaft geometry, to encourage agglomeration of the carboxymethyl cellulose. In one embodiment, the process further comprises adjusting the spray rate and residence time in the ring layer mixer to discourage granulation of the carboxymethyl cellulose.

The step of drying the agglomerates by non-contact drying means, in one embodiment, includes those where the non-contact drying means is a fluid bed dryer. In one embodiment, the present invention provides a further step, comprising drying the carboxymethyl cellulose at a temperature of more than about 50° C., preferably about 70° C. Alternatively, the carboxymethyl cellulose is dried to a residual water content of less than about 10% by weight, irrespective of temperature.

In one embodiment, the aqueous dispersible carboxymethyl cellulose disperses well with minimal lumps visible. In one embodiment, the aqueous dispersible carboxymethyl cellulose hydrates quickly, with times to 50% viscosity of less than a minute, times to 90% viscosity of less than 8 minutes, preferably less than 6 minutes, and times to 95% viscosity of less than 15 minutes. As can be appreciated, the higher the raw material viscosity, the longer the viscosity build up (the time in min where the given % of the final torque was obtained).

In one embodiment, the aqueous dispersible carboxymethyl cellulose has a bulk density that is at least 70% of the raw material CMC's bulk density, preferably at least 72%, preferably at least 74%, preferably at least 76%, preferably at least 78%, and most preferably at least 80%.

In one embodiment, the aqueous dispersible carboxymethyl cellulose has an angle of repose that is only 5% greater than, preferably substantially the same as, and more preferably, less than the raw material CMC's angle of repose. In one embodiment, the aqueous dispersible carboxymethyl cellulose has a bulk density/angle of repose that is greater than 9.

In one embodiment, the aqueous dispersible carboxymethyl cellulose has significantly reduced dust as compared to the raw material.

The inventive aqueous dispersible carboxymethyl cellulose is useful in any conventional application requiring carboxymethyl cellulose where improved dispersion and hydration, improved flowability, and/or lower dust content, is beneficial. Examples include uses in food (including solid, gel, or beverage forms), pharmaceuticals, personal care, oil drilling fluids, paper processing, detergents, and thickeners for latexes and adhesives.

In one embodiment, the present invention includes a food containing aqueous dispersible carboxymethyl cellulose. Non-limiting examples of contemplated foods include bakery products, beverages (including, for example, soft drinks, sports drinks, dairy beverages, fruit juices, slushes, smoothies, and alcoholic beverages, including wine), cereals, dairy products, delicatessen foods, fruit products, vegetable products, meat products, fish products, pasta, snacks, soups, sauces, dressings, soy products, spreads, confectionary products, and potato products.

In one embodiment, the present invention includes a pet food containing aqueous dispersible carboxymethyl cellulose.

### EXAMPLES

The following examples are for illustrative purposes only and are not intended to limit the scope of the present invention.

### Example 1

Exemplary aqueous dispersible carboxymethyl celluloses according to the present invention are created as follows. The starting material (raw CMC) is fed continuously in the ring-layer mixer (CORIMIX CM 20) running at a flow rate of approximately 3000 rpm. Alternatively, acceptable residence time can be achieved by adjusting tip speed or Froude number. Water is sprayed in the mixer on the product. Older systems use injection of the water through the jacket, whereas newer systems spray through the fast rotating axle. Sufficient water is added so that the wetted agglomerate leaving the mixer has a moisture content of approximately 25-30%. The obtained agglomerate is subsequently dried in a fluid bed dryer (Huettlin Mycrolab) at an air inlet temperature of 50-120° C., preferably 70° C., until the product has reached a temperature of approximately 52° C. A summary of conditions is recited in TABLE 1.

TABLE 1

| | | | RLM CE | Drying | Product |
|---|---|---|---|---|---|
| Starting | Water | RLM | flow | Temp | Temp |
| material | % | rpm | (kg/h) | (° C.) | (° C.) |
| CRT 30 CMC | 30 | 3000 | 150 | 70 | 52 |
| CRT 2000 CMC | 30 | 3000 | 150 | 70 | 52 |
| CRT 40000 CMC | 30 | 3000 | 150 | 70 | 52 |

### Example 2

### Comparative

Comparative aqueous dispersible carboxymethyl cellulose are created as follows. The starting material is made in a batch process in the fluid bed processor. After conventionally fluidizing the material, water is top sprayed through a nozzle on the fluidized material. The air inlet temperature is held constant at approximately 50° C. during spraying while the product temperature is approximately 35° C. The addition of water is stopped when the ratio of added water/(sum of added water and CMC) is 0.25 or 0.3.

The obtained agglomerate is subsequently dried in a fluid bed dryer (Huettlin Mycrolab) at an air inlet temperature of 70° C. until the product has reached a temperature of approx. 52° C. A summary of conditions is recited in TABLE 2.

TABLE 2
(Comparative)

| | | FBA air | FBA | Drying | Product |
|---|---|---|---|---|---|
| Starting | Water | inlet | product | Temp | Temp |
| material | % | (° C.) | (° C.) | (° C.) | (° C.) |
| CRT 30 CMC | 25 | 50 | 35 | 70 | 52 |
| CRT 2000 CMC | 30 | 50 | 33 | 70 | 52 |
| CRT 40000 CMC | 30 | 50 | 28 | 70 | 52 |

### Example 3

Batches 1-3 were created substantially according to the protocol of Example 1, and are characterized with the results being recited in TABLE 3.

TABLE 3

| | | | | | | Time |
|---|---|---|---|---|---|---|
| | Bulk | | Angle of | | Powder | to 90% |
| | density | Dust | repose | Dispers- | Flow | visc. |
| | (g/L) | (% <63 μm) | (°) | ibility | (g/min) | (min) |
| Batch 1 | 531 | 5.1 | 40.0 | good | 96.7 | 2 |
| Batch 2 | 480 | 7.0 | 42.3 | good | 88.8 | 5 |
| Batch 3 | 404 | 17.4 | 42.7 | good | 51.7 | 6 |

The bulk density is determined by weighing a completely filled beaker of known volume. Values given are average values of three measurements. The dust content is the fraction smaller than 63 μm after sieving the product accordingly.

The angle of repose is determined with a Hosokawa Micron Powder Characteristics Tester (model PT-R, 1999, software version 1.02) at an vibration adjustment of ˜2.5.

The powder flow speed is measured with the same instrument, using the same method and the same vibration adjustment, as flow by weight through the system for 20 seconds. After the flow becomes consistent, three measurements are combined and averaged.

The dispersibility is tested in a beaker, 0.5 g of the final product is dispersed in a beaker containing 49.5 g water (yielding a 1 weight % solution) stiffing at 500-750 rpm. Directly after dispersion, a visual assessment is made by a trained technician to determine the quality of the solution, whether lumps can be seen, and how well the sample is distributed throughout the entire solution. The viscosity build up is measured by analyzing the torque over the time (using a Haake VT 550 viscometer) at 600 rpm for 30 min. The torque data of the last 5 min of the measurement were averaged and defined as final torque level. 90% viscosity build up was defined as the time in min where 90% of the final torque was obtained. 50% viscosity build up was less than a minute for all samples, and 95% viscosity build up was reached at 4, 10, and 14 minutes for Batches A, B, and C respectively.

### Example 4

### Comparative

Comparative Batches A-C were created substantially according to the protocol of Example 2, and are characterized below, along with the raw material (without processing). The results are recited in TABLE 4.

TABLE 4
(Comparative)

| | Bulk | Dust | Angle of | | Time |
|---|---|---|---|---|---|
| | density | (% < 63 | repose | Dispers- | to 90% |
| | (g/L) | μm) | (°) | ibility | visc. |
| CRT 30 CMC | 658 | 46.9 | 41.0 | Not | 9 |
| | | | | dispersible | |
| CRT 2000 CMC | 650 | 49.7 | 41.6 | Not | 17 |
| | | | | dispersible | |
| CRT 40000 CMC | 559 | 65.7 | 41.8 | Not | 19 |
| | | | | dispersible | |
| Batch A | 258 | 13.6 | 48.2 | Very good | 0.6 |
| Batch B | 295 | 14.9 | 49.4 | Very good | 3 |
| Batch C | 232 | 11.1 | 49.4 | Very good | 8 |

Using a Hosokawa Micron Powder Characteristics Tester, the powder flow speed was measured as flow by weight through the system for 20 seconds. After the flow becomes consistent, three measurements are combined and averaged. Batch A had a flow of 23.2 g/min. Batch B had a flow of 17.1 g/min. Batch C had a flow of 17.7 g/min. As can be seen, fluid bed agglomeration (comparative Batches A-C) resulted in excellent dispersibility, but very poor flowability as compared with the results from TABLE 3. Accordingly, inventive Batches 1-3 show desirable dispersion, hydration, and dust content, yet exhibits improved flowability.

### Example 5

Exemplary foods including aqueous dispersible carboxymethyl celluloses according to the present invention are prepared as follows. Milk (3.5% fat content) is heated to about 45° C. and mixed with yoghurt culture. The mixture is fermented at a constant temperature of about 35° C. for approximately 17 hours to form a base yoghurt mixture.

0.24 g of aqueous dispersible carboxymethyl cellulose created substantially according to the protocol of Example 1, and equivalent to Batch 2 from Example 3, was added to 120 g of the base yoghurt mixture using about 3 minutes of stirring with a paddle stirrer at 300 rpm. Visual inspection by a trained panelist at 15 minutes, 1 hour, and 48 hours, revealed that only a little lump formation could be observed both on the surface and inside the yoghurt, and that the size and amount of lumps was minimal enough to be considered acceptable in the food industry.

### Example 6

### Comparative

As a comparison, 0.24 g of comparative carboxymethyl cellulose created substantially according to the protocol of Example 2, and equivalent to Batch B from Example 4, was added to 120 g of base yoghurt mixture (prepared substantially according to Example 5), using about 3 minutes of stiffing with a paddle stirrer at 300 rpm. Visual inspection by a trained panelist at 15 minutes, 1 hour, and 48 hours, revealed a lot of big lumps floating on the surface of the yogurt, such that the severity of the lumps would not be considered acceptable in the food industry.

It is understood that the present invention is not limited to the embodiments specifically disclosed and exemplified herein. Various modifications of the invention will be apparent to those skilled in the art. Such changes and modifications may be made without departing from the scope of the appended claims.

Moreover, each recited range includes all combinations and subcombinations of ranges, as well as specific numerals contained therein. Additionally, the disclosures of each patent, patent application, and publication cited or described in this document are hereby incorporated herein by reference, in their entireties.

1. A process for producing an aqueous dispersible carboxymethyl cellulose, comprising:
in a continuous process, introducing carboxymethyl cellulose into a high shear mixer;
adding at least 20 percent water by weight to the carboxymethyl cellulose without additional surface treatment additives;
forming carboxymethyl cellulose agglomerates; and
drying the agglomerates by non-contact drying means to form the aqueous dispersible carboxymethyl cellulose.

2. The process of claim 1, comprising adding at least 25 percent water by weight to the carboxymethyl cellulose without additional surface treatment additives.

3. The process of claim 1, comprising adding at least 30 percent water by weight to the carboxymethyl cellulose without additional surface treatment additives.

4. The process of claim 1, wherein the high shear mixer is a ring layer mixer.

5. The process of claim 4, further comprising adjusting the residence time in the ring layer mixer to encourage agglomeration of the carboxymethyl cellulose.

6. The process of claim 4, further comprising adjusting the spray rate and residence time in the ring layer mixer to discourage granulation of the carboxymethyl cellulose.

7. The process of claim 6, comprising adding at least 35 percent water by weight to the carboxymethyl cellulose without additional surface treatment additives.

8. The process of claim 1, wherein the carboxymethyl cellulose has a viscosity of about 10 to about 120,000 mPa/s for a two percent solution.

9. The process of claim 1, wherein the carboxymethyl cellulose has a DS of about 0.4 to about 1.4.

10. The process of claim 1, wherein the aqueous dispersible carboxymethyl cellulose has a bulk density that is greater than 350 g/L, preferably greater than 400 g/L.

11. The process of claim 1, wherein the aqueous dispersible carboxymethyl cellulose has an angle of repose that is less than 47, preferably less than 45, more preferably less than 43.

12. The process of claim 1, wherein the aqueous dispersible carboxymethyl cellulose has a bulk density/angle of repose that is greater than 8.

13. The process of claim 1, wherein the non-contact drying means is a fluid bed dryer.

14. The process of claim 13, further comprising maintaining the temperature at about 70° C.

15. A carboxymethyl cellulose that has an angle of repose that is less than 47, preferably less than 45, more preferably less than 43, and a bulk density that is greater than 350 g/L, preferably greater than 400 g/L.

16. A food product including the carboxymethyl cellulose of claim 15.
